(19) United States
(12) Patent Application Publication
(10) Pub. No.: US 2017/0195614 A1
(43) Pub. Date: Jul. 6, 2017

(54) METHOD AND ELECTRONIC DEVICE FOR PLAYING VIDEO

(71) Applicants: LE HOLDINGS (BEIJING) CO., LTD., Beijing (CN); LE SHI INTERNET INFORMATION & TECHNOLOGY COR., BEIJING, Beijing (CN)

(72) Inventor: Xiaofei ZAN, Beijing (CN)

(21) Appl. No.: 15/243,776

(22) Filed: Aug. 22, 2016

Related U.S. Application Data
(63) Continuation of application No. PCT/CN2016/089259, filed on Jul. 7, 2016.

(30) Foreign Application Priority Data
Dec. 31, 2015 (CN) 201511026810.5

(51) Int. Cl. H04N 5/45; H04N 5/60

(52) U.S. Cl. CPC H04N 5/45; H04N 5/60

(57) ABSTRACT

The present disclosure relates to a method and an electronic device for playing video. The method includes: generating a video window with a preset size on a display screen when a first video is played on the display screen and an instruction for synchronously playing is received; obtaining a second video when an instruction for synchronously playing the second video is received; and playing the second video in the video window. The solution provided by the present disclosure may play the second video in the video window at the same time when the first video is being played on the display screen, thus it can be ensured that a user may check whether the second video is interesting when he is watching the first video, thereby ensuring a continuity in user's watching of the first video.

### CROSS REFERENCE TO RELATED APPLICATIONS

The present application is a continuation of International Application No. PCT/CN2016/089259, filed Jul. 7, 2016, which in turn claims priority to Chinese Application No. 201511026810.5, filed Dec. 31, 2015, the entire contents of which are incorporated herein by reference.

### TECHNICAL FIELD

The present disclosure relates to the field of communication technology, and more particularly, to a method and an electronic device for playing video.

### BACKGROUND

At present, when a user is watching videos by using a display screen of a terminal, if the user wants to see whether other videos are interesting, the video being played currently is required to be switched to the other videos, so that the other videos can be played on the display screen at the terminal.

Only when the video being played currently is switched to other videos can the user know whether the other videos are interesting. Therefore, the user has to change videos even if the user wants to continue watching the video being played currently, because there is no way to check whether other videos are interesting when he is watching the video being played currently. The existing technology for playing video thus reduces continuity in user's watching of videos, thereby deteriorating the user's view experience.

### SUMMARY

The present disclosure provides a method and an electronic device for playing video, wherein two videos are synchronously played, and thereby the user's view experience is improved.

According to a first aspect of the embodiments of the present disclosure, a method for playing video is provided, which includes:

generating a video window with a preset size on a display screen when a first video is played on the display screen and an instruction for synchronously playing is received;

obtaining a second video when an instruction for synchronously playing the second video is received; and

playing the second video in the video window.

The embodiments of the present disclosure further provide a non-transitory computer-readable medium storing instructions that, when executed by an electronic device with a touch-sensitive display, cause the electronic device to execute any one of the method for playing video aforementioned.

The embodiments of the present disclosure further provide an electronic device, which includes: at least one processor; and a memory communicably connected with the at least one processor for storing instructions executable by the at least one processor, wherein execution of the instructions by the at least one processor causes the at least one processor to execute any one of the method for playing video aforementioned.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for playing video provided by an example of the present disclosure.

FIG. 2 is a flowchart of another method for playing video provided by an example of the present disclosure.

FIG. 3 is a flowchart of yet another method for playing video provided by an example of the present disclosure.

FIG. 4 is flowchart of yet another method for playing video provided by an example of the present disclosure.

FIG. 5 is flowchart of yet another method for playing video provided by an example of the present disclosure.

FIG. 6 is a schematic diagram of the configuration of the hardware for the method for playing video provided by an example of the present disclosure.

### DETAILED DESCRIPTION

The technical solution in the examples of the present disclosure will be explicitly and completely described in combination with figures herein as follows. Obviously, the examples as described are merely a part, rather than all of examples of the present disclosure. Based on the examples of the present disclosure, all the other examples obtained by one of ordinary skilled in the art without inventive efforts will fall into the scope of the present disclosure.

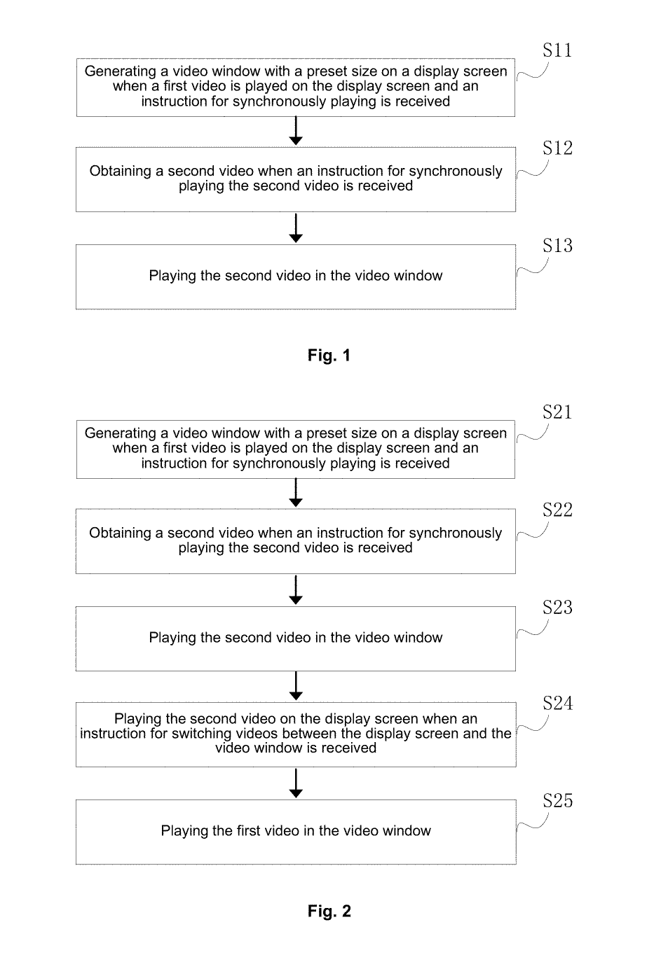

FIG. 1 is a flowchart of a method for playing video provided by an example of the present disclosure. The method for playing video shown in FIG. 1 can be applied to a terminal. According to the method for playing video provided by the present disclosure, a second video can be played in a video window at the same time when a first video is being played on a display screen, thus it can be ensured that the user can check whether the second video is interesting when he is watching the first video, then the continuity in the user's watching of the first video can be ensured, and accordingly the solution provided by the present disclosure can improve the user's view experience. The method includes the following steps.

In step S11: a video window with a preset size is generated on a display screen when a first video is played on the display screen and an instruction for synchronously playing is received.

The method provided by the present disclosure is applied to a terminal capable of playing video, wherein the terminal may be a device such as smart TV, smart mobile phone, tablet computer, desktop computer or laptop and the like.

The first video, the second video, the third video up to the n^{th} video mentioned in the present disclosure are all videos, which are named in such way merely for distinguishing from different videos.

The video may be not only a video on demand, but also a live video. The video on demand means that the files of videos are stored in a server, wherein when some video on demand is required to be played at a terminal, the terminal will invoke the video on demand from the server. The video on demand may also be stored within the terminal in advance. The live video means a video being live played, wherein when some live video is required to be played at a terminal, the terminal will invoke a live video streaming of the live video from the server.

When a first video is played on a display screen of a terminal, if an instruction for synchronously playing inputted by the user is received, it means that the user wants to watch other videos at the same time when he is watching the first video. Therefore, a video window with a preset size is required to be generated on the display screen of the terminal.

A physical button can be arranged on the terminal, such that an instruction for synchronously playing is triggered when the user pushes the physical button. A virtual button can also be arranged within software for playing video in the terminal, such that an instruction for synchronously playing can be triggered when the virtual button is clicked.

The size of the video window can be preset. For example, supposing that the display screen of the terminal has a length of 50 cm and a width of 40 cm, the user may preset the length of the video window to be 15 cm, and the width thereof to be 15 cm. When the first video is played on the display screen of the terminal and an instruction for synchronously playing is received, a video window having a same length and width of 15 cm is generated on the display screen.

In step S12: a second video is obtained when an instruction for synchronously playing the second video is received.

After the video window with a preset size is generated on the display screen of the terminal, a video menu can be shown at the terminal to facilitate the user to select. When the user selects a second video on video menu, the terminal will receives an instruction inputted by the user for synchronously playing the second video, thus the terminal will obtain the second video.

For example, supposing that a video A is played on the display screen of the terminal, if an instruction for synchronously playing inputted by the user is received, it means that the user wants to watch other videos at the same time when he is watching the video A, so a video window with a preset size is required to be generated on the display screen of the terminal. After that, a video menu will be shown on the display screen of the terminal. Supposing that videos that can be played on the video menu include a video B, a video C, a video D, and a video E, the user can click videos on the video menu when viewing them. Supposing that the user click the video D on the video menu, the terminal will receive an instruction for synchronously playing the video D, thus the terminal will obtain the video D from the server.

A physical button can be arranged on the terminal, such that an instruction for synchronously playing the second video is triggered when the user pushes the physical button. A virtual button can also be arranged within software for playing video in the terminal, such that an instruction for synchronously playing the second video can be triggered when the virtual button is clicked.

In step S13: the second video is played in the video window.

After obtained by the terminal, the second video can be played on the display screen of the terminal, so as to ensure the user to watch the second video at the same time when he is watching the first video.

In the example shown in FIG. 1, when a first video is played on a display screen, if the user wants to see whether other videos are interesting, he may input an instruction for synchronously playing, such that a video window with a preset size is generated on the display screen. When the user wants to see whether a second video is interesting, he may input an instruction for synchronously playing the second video. When an instruction for synchronously playing the second video is received, the second video can be played in the generated video window, such that the second video can also be played in the video window at the same time when the first video is being played on the display screen, thus it can be ensured that the user can check whether the second video is interesting when he is watching the first video. Therefore, continuity in the user's watching of the first video can be ensured, and accordingly the solution provided by the present disclosure can improve the user's view experience.

FIG. 2 is a flowchart of another method for playing video provided by the example of the present disclosure. FIG. 2 is an optional example based on FIG. 1, and in the example shown in FIG. 2, the part identical with the example shown in FIG. 1 may be referred to the description and explanation in the example shown in FIG. 1. The method shown in FIG. 2 includes the steps as follows.

In step S21: a video window with a preset size is generated on a display screen when a first video is played on the display screen and an instruction for synchronously playing is received.

In step S22: a second video is obtained when an instruction for synchronously playing the second video is received.

In step S23: the second video is played in the video window.

In step S24: the second video is played on the display screen when an instruction for switching videos between the display screen and the video window is received.

After the second video is played in the video window, if the user prefers the second video, he may input an instruction for switching videos between the display screen and the video window to the terminal. When receiving the instruction for switching videos between the display screen and the video window inputted by the user, the terminal will play the second video in the display screen, and play the first video in the video window.

If the user does not want to continue watching the first video in the video window, he may input an instruction for closing the video window to the terminal. When receiving the instruction for closing the video window inputted by the user, the terminal will close the video window and only play the second video on the display screen.

In step S25: the first video is played in the video window.

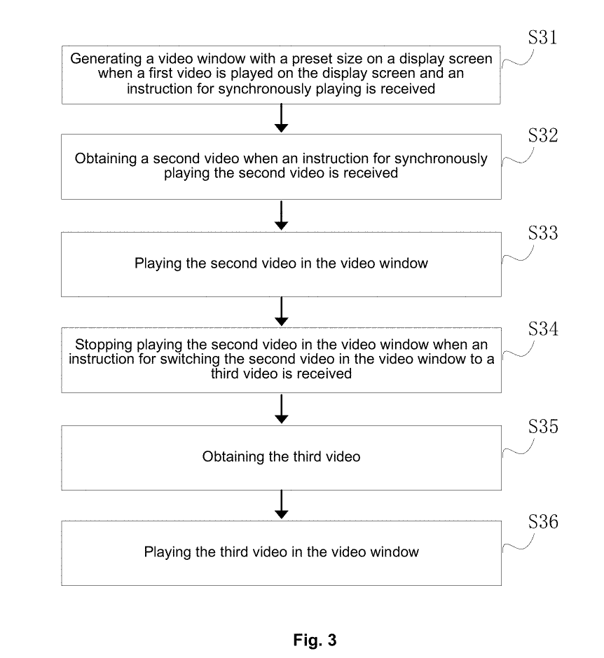

FIG. 3 is a flowchart of yet another method for playing video provided by the example of the present disclosure. FIG. 3 is an optional example based on FIG. 1, and in the example shown in FIG. 3, the part identical with the example shown in FIG. 1 may be referred to the description and explanation in the example shown in FIG. 1. The method shown in FIG. 3 includes the steps as follows.

In step S31: a video window with a preset size is generated on a display screen when a first video is played on the display screen and an instruction for synchronously playing is received.

In step S32: a second video is obtained when an instruction for synchronously playing the second video is received.

In step S33: the second video is played in the video window.

In step S34: the second video in the video window is stopped playing when an instruction for switching the second video in the video window to a third video is received.

After the second video is played in the video window, if the user does not like the second video played in the video window, he may select other videos from a video playbill. When the user selects a third video from the video playbill, the terminal will receive an instruction for switching the second video in the video window to a third video, and stop playing the second video in the video window.

In step S35: the third video is obtained.

After the second video in the video window is stopped playing, the terminal can obtain the third video. When the terminal obtains the third video, the terminal can play the third video in the video window, so as to meet the demand on switching videos in the video window by the user.

In step S36: the third video is played in the video window.

After the third video is played in the video window, if the user does not like the third video played in the video window, he may continue selecting other videos from the video playbill, and the terminal will also change to other videos followed by the above step, so as to ensure the user to select a satisfactory video.

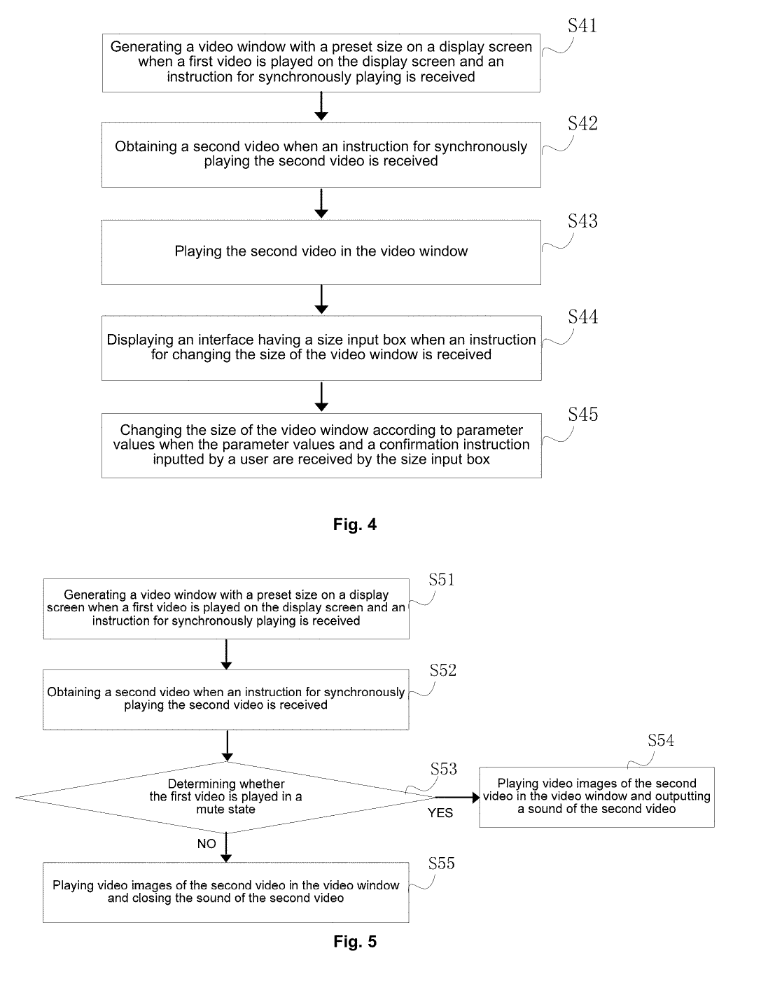

FIG. 4 is flowchart of another yet method for playing video provided by the example of the present disclosure. FIG. 4 is an optional example based on FIG. 1, and in the example shown in FIG. 4, the part identical with the example shown in FIG. 1 may be referred to the description and explanation in the example shown in FIG. 1. The method shown in FIG. 4 includes the following steps.

In step S41: a video window with a preset size is generated on a display screen when a first video is played on the display screen and an instruction for synchronously playing is received.

In step S42: a second video is obtained when an instruction for synchronously playing the second video is received.

In step S43: the second video is played in the video window.

In step S44: an interface having a size input box is displayed when an instruction for changing the size of the video window is received

To ensure user's view comfort, the user may adjust the size of the video window on the terminal. When the terminal receives an instruction for changing the size of the video window, an interface having a size input box is displayed on the display screen of the terminal, so as to facilitate the user to enter a size that he thinks suitable.

In step S45: the size of the video window is changed according to parameter values when the parameter values and a confirmation instruction inputted by the user are received by the size input box.

The parameter values refer to the size of the video window. For example, supposing that the video window is in rectangle shape, the parameter values are the length and width of the video window. For another example, supposing that the video window is in circular shape, the parameter values are the radius of the video window.

After an interface having a size input box is displayed on the display screen of the terminal, the user may enter parameter values of the video window into the size input box. After that the parameter values of the video window are inputted, the user may click “confirm” button on the interface having the size input box, such that the size input box of the terminal can receive the parameter values and the confirmation instruction inputted by the user. When the size input box of the terminal receives the parameter values and the confirmation instruction inputted by the user, the terminal will change the size of the video window according to the parameter values.

For example, supposing that the display screen of the terminal has a length of 50 cm and a width of 40 cm, the user may preset the length of the video window to be 15 cm, and the width thereof to be 15 cm. When the first video is played on the display screen of the terminal and an instruction for synchronously playing is received, a video window having the same length and width of 15 cm is generated on the display screen. When receiving an instruction for synchronously playing a second video, the terminal will obtain the second video, and play the second video in the video window. At this time, the user may think the size of the video window is too small, and then inputs an instruction for changing the size of the video window to the terminal. When receiving the instruction for changing the size of the video window, the terminal will display an interface having a length input box and a width input box. Supposing that the user enters 25 cm into the length input box and 20 cm into the width input box, and then clicks the “confirm” button on the interface, the size input box of the terminal receives the parameter values and the confirmation instruction inputted by the user. The terminal will modify the length of the video window to 25 cm and the width of the video window to 20 cm. Finally, the terminal will show the video window having the modified length of 25 cm and width of 20 cm.

For another example, supposing that the display screen of the terminal has a length of 50 cm and a width of 40 cm, due to a circular shape of the video window, the user may preset the radius of the video window to be 10 cm. When the first video is played on the display screen of the terminal and an instruction for synchronously playing is received, the video window having a radius of 10 cm will be generated on the display screen. When receiving an instruction for synchronously playing the second video, the terminal will obtain the second video, and play the second video in the video window. At this time, the user may think the size of the video window is too large, and then inputs an instruction for changing the size of the video window to the terminal. When receiving instruction for changing the size of the video window, the terminal will display an interface having a radius input box. Supposing that the user enters 8 cm into the radius input box, and then clicks the “confirm” button on the interface, the size input box of the terminal receives the parameter values and the confirmation instruction inputted by the user, and will modify the radius of the video window to 8 cm. Finally, the terminal will show the video window having the modified radius of 8 cm.

FIG. 5 is flowchart of yet another method for playing video provided by the example of the present disclosure. FIG. 5 is an optional example based on FIG. 1, and in the example shown in FIG. 5, the part identical with the example shown in FIG. 1 may be referred to the description and explanation in the example shown in FIG. 1. The method shown in FIG. 5 includes the step as follows.

In step S51: a video window with a preset size is generated on a display screen when a first video is played on the display screen and an instruction for synchronously playing is received.

In step S52: a second video is obtained when an instruction for synchronously playing the second video is received.

In step S53: whether the first video is played in a mute state is determined. When the first video is played in a mute state, step S54 is triggered. When the first video is played in a non-mute state, step S55 is triggered.

After the terminal obtains the second video, to prevent the first video and the second video from making sound simultaneously, the terminal needs to determine whether the first video is played in a mute state.

When the terminal determines that the first video is played in a mute state, it means that the first video does not make a sound, then the terminal may play video images of the second video in the video window, and output a sound of the second video, such that the terminal currently plays video images of both the first video and the second video at the same time, but only outputs the sound of the second video.

When the terminal determines that the first video is played in a non-mute state, it means that the first video is making a sound, then the terminal may play video images of the second video in the video window, close the sound of the second video, such that the terminal currently plays video images of both the first video and the second video at the same time, but only outputs the sound of the first video.

To meet user's demand, the user may further arrange sounds of the first video and the second video flexibly within the terminal.

In step S54: video images of the second video are played in the video window and a sound of the second video is outputted.

In step S55: video images of the second video are played in the video window and the sound of the second video is closed.

An example of the present disclosure provides a device for preview playing. The device includes a generating module 11, a first obtaining module 12 and a first playing module 13.

The generating module 11 is configured to generate a video window with a preset size on a display screen when a first video is played on the display screen and an instruction for synchronously playing is received.

The first obtaining module 12 is configured to obtain the second video when an instruction for synchronously playing the second video is received.

The first playing module 13 is configured to play the second video in the video window.

An example of the present disclosure provides another device for preview playing. The device includes a generating module 21, a first obtaining module 22, a first playing module 23, a second playing module 24 and a third playing module 25.

The generating module 21 is configured to generate a video window with a preset size on a display screen when a first video is played on the display screen and an instruction for synchronously playing is received.

The first obtaining module 22 is configured to obtain the second video when an instruction for synchronously playing the second video is received.

The first playing module 23 is configured to play the second video in the video window.

The second playing module 24 is configured to play the second video on the display screen when an instruction for switching videos between the display screen and the video window is received.

The third playing module 25 is configured to play the first video in the video window.

An example of the present disclosure provides yet another device for preview playing. The device includes a generating module 31, a first obtaining module 32, a first playing module 33, a stop playing module 34, a second obtaining module 35 and a fourth playing module 36.

The generating module 31 is configured to generate a video window with a preset size on a display screen when a first video is played on the display screen and an instruction for synchronously playing is received.

The first obtaining module 32 is configured to obtain the second video when an instruction for synchronously playing the second video is received.

The first playing module 33 is configured to play the second video in the video window.

The stop playing module 34 is configured to stop playing the second video in the video window when an instruction for switching the second video in the video window to a third video is received.

The second obtaining module 35 is configured to obtain the third video.

The fourth playing module 36 is configured to play the third video in the video window.

An example of the present disclosure provides yet another device for preview playing. The device includes a generating module 41, a first obtaining module 42, a first playing module 43, a display module 44 and a change module 45.

The generating module 41 is configured to generate a video window with a preset size on a display screen when a first video is played on the display screen and an instruction for synchronously playing is received.

The first obtaining module 42 is configured to obtain the second video when an instruction for synchronously playing the second video is received.

The first playing module 43 is configured to play the second video in the video window.

The display module 44 is configured to display an interface having a size input box when an instruction for changing the size of the video window is received.

The change module 45 is configured to change the size of the video window according to parameter values when the parameter values and a confirmation instruction inputted by a user are received by the size input box.

An example of the present disclosure provides yet another device for preview playing. The device includes a generating module 51, a first obtaining module 52 and a first playing module 53 including a determining submodule 531, a first triggering submodule 532 and a second triggering submodule 533.

The generating module 51 is configured to generate a video window with a preset size on a display screen when a first video is played on the display screen and an instruction for synchronously playing is received.

The first obtaining module 52 is configured to obtain the second video when an instruction for synchronously playing the second video is received.

The first playing module 53 is configured to play the second video in the video window.

The determining submodule 531 is configured to determine whether the first video is played in a mute state.

The first triggering submodule 532 is configured to play video images of the second video in the video window and output a sound of the second video when the first video is played in the mute state.

The second triggering submodule 533 is configured to play video images of the second video in the video window and close the sound of the second video when the first video is played in a non-mute state.

In regard to the devices in the above examples, the specific modes of operating the respective modules have been illustrated in the examples related to the methods, which will not be described again here in details.

The embodiments of the present disclosure further provide a non-transitory computer-readable storage medium storing executable instructions that, when executed by an electronic device with a touch-sensitive display, cause the electronic device to execute any one of the method for playing video aforementioned.

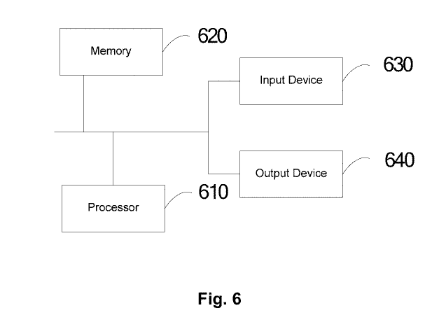

FIG. 6 is a schematic diagram of the hardware configuration of the electronic device for executing the method for playing video provided by embodiments of the present disclosure. Referring to FIG. 6, the device includes: one or more processors 610 and a memory 620. In FIG. 6, only one processor 610 is shown as an example.

The device for executing the method for playing video may further include: an input device 630 and an output device 640.

The processor 610, the memory 620, the input device 630 and the output device 640 may be connected by bus or other means. FIG. 6 shows the devices are connected by bus as an example.

The memory 620 is a non-volatile computer-readable storage media, which may be used to store non-volatile software program, non-volatile computer-executable program and module, such as the program instruction/module corresponding to the method for playing video of the examples of the present disclosure. The processor 610 may perform various functions and applications of the server and process data by running the non-volatile software program, instruction and module stored in the memory 620, so as to realize the method for playing video of the examples aforementioned.

The memory 620 may include a program storage area and a data storage area, wherein the program storage area may store an operation system and an application program for achieving at least one function; the data storage area may store data established according to the use of the device for playing video. In addition, the memory 620 may include a high-speed random access memory, and may further include a non-volatile memory, such as at least one magnetic disk memory, flash memory or other non-volatile solid state memory. In some examples, the memory 620 may preferably include memories set remotely with respect to the processor 610, wherein these remote memories may be connected to the device for playing video via the network. The examples of the network include but are not limited to internet, intranet, local area network (LAN), mobile communication network and their combinations.

The input device 630 may receive the information of a number or a character as inputted, and generate key input signals relating to the user setting and function control of the device for playing video. The output device may include a display device such as a display screen.

The one or more modules are stored in the memory 620. When the one or more modules are executed by one or more processors 610, the method for playing video according to any of the above examples are executed.

The above product may execute the method provided by the examples of the present disclosure, and has the corresponding functional module for executing the method, and therefore has beneficial effect. For the details that are not fully described in this example, please refer to the methods provided by the examples of the present disclosure.

The electronic device of the examples of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g., iPhone), multimedia phone, feature phone and low-level phone, etc.

(2) Ultra mobile personal computer device, which belongs to the range of personal computer, has the function of computing and processing and generally can also be used in mobile internet. This kind of terminal includes: PDA, MID and UMPC device, etc., such as iPad.

(3) Portable entertainment device, which may display and play multimedia contents. This kind of device includes: audio and/or video player (e.g., iPod), hand-held game machine, electronic book device, smart toy and portable vehicle navigation device.

(4) Server, which is a device that provides computing service. The configuration of the server includes processor, hard disk, memory and system bus, etc. The architecture of a server is similar to that of a general computer. However, the sever has a higher demanding with respect to the processing ability, stability, reliability, safety, expansibility and manageability, etc., because the server is required to provide more reliable service.

(5) Other electronic device having function of data interaction.

The examples of the device have been described above for illustrative purposes only, wherein the units described as separated members may or may not be separated physically. The members shown as units may or may not be physical unit, that is, they may be located at one place, or may be distributed to a number of units in a network. The objective of the examples of the present disclosure may be achieved by selecting a part or all of the modules according to actual demand.

From the description of the above examples, the person skilled in the art may understand clearly that respective examples may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk, etc., and may include a number of instructions for making a computer device (which may be a personal computer, a server or a network device, etc.) execute the method according to the respective examples or a part of an example.

It should be noted that the examples as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A method for playing video, which is applied to a terminal, wherein the method comprises:
generating a video window with a preset size on a display screen when a first video is played on the display screen and an instruction for synchronously playing is received;
obtaining a second video when an instruction for synchronously playing the second video is received; and
playing the second video in the video window.

2. The method for playing video according to claim 1, wherein after the step of playing the second video in the video window, the method further comprises:
playing the second video on the display screen when an instruction for switching videos between the display screen and the video window is received; and
playing the first video in the video window.

3. The method for playing video according to claim 1, wherein after the step of playing the second video in the video window, the method further comprises:
stopping playing the second video in the video window when an instruction for switching the second video in the video window to a third video is received;
obtaining the third video; and
playing the third video in the video window.

4. The method for playing video according to claim 1, wherein after the step of playing the second video in the video window, the method further comprises:
displaying an interface having a size input box when an instruction for changing the size of the video window is received; and
changing the size of the video window according to parameter values when the parameter values and a confirmation instruction inputted by a user are received by the size input box.

5. The method for playing video according to claim 1, wherein the step of playing the second video in the video window comprises:
determining whether the first video is played in a mute state;
playing video images of the second video in the video window and outputting a sound of the second video when the first video is played in the mute state; and
playing video images of the second video in the video window and closing the sound of the second video when the first video is played in a non-mute state.

6. A non-transitory computer-readable storage medium storing executable instructions that when executed by an electronic device with a touch-sensitive display, cause the electronic device to:
generate a video window with a preset size on a display screen when a first video is played on the display screen and an instruction for synchronously playing is received;
obtain a second video when an instruction for synchronously playing the second video is received; and
play the second video in the video window.

7. The non-transitory computer-readable storage medium according to claim 6, wherein after playing the second video in the video window, the executable instructions further cause the electronic device to:
play the second video on the display screen when an instruction for switching videos between the display screen and the video window is received; and
play the first video in the video window.

8. The non-transitory computer-readable storage medium according to claim 6, wherein after playing the second video in the video window, the executable instructions further cause the electronic device to:
stop playing the second video in the video window when an instruction for switching the second video in the video window to a third video is received;
obtain the third video; and
play the third video in the video window.

9. The non-transitory computer-readable storage medium according to claim 6, wherein after playing the second video in the video window, the executable instructions further cause the electronic device to:
display an interface having a size input box when an instruction for changing the size of the video window is received; and
change the size of the video window according to parameter values when the parameter values and a confirmation instruction inputted by a user are received by the size input box.

10. The non-transitory computer-readable storage medium according to claim 6, wherein in the step of playing the second video in the video window the executable instructions further cause the electronic device to:
determine whether the first video is played in a mute state;
play video images of the second video in the video window and outputting a sound of the second video when the first video is played in the mute state; and
play video images of the second video in the video window and closing the sound of the second video when the first video is played in a non-mute state.

11. An electronic device, comprising:
at least one processor; and
a memory communicably connected with the at least one processor for storing instructions executable by the at least one processor, wherein execution of the instructions by the at least one processor causes the at least one processor to:
generate a video window with a preset size on a display screen when a first video is played on the display screen and an instruction for synchronously playing is received;
obtain a second video when an instruction for synchronously playing the second video is received; and
play the second video in the video window.

12. The electronic device according to claim 11, wherein after playing the second video in the video window, the at least one processor is further caused to:
play the second video on the display screen when an instruction for switching videos between the display screen and the video window is received; and
play the first video in the video window.

13. The electronic device according to claim 11, wherein after playing the second video in the video window, the at least one processor is further caused to:
stop playing the second video in the video window when an instruction for switching the second video in the video window to a third video is received;
obtain the third video; and
play the third video in the video window.

14. The electronic device according to claim 11, wherein after playing the second video in the video window, the at least one processor is further caused to:
display an interface having a size input box when an instruction for changing the size of the video window is received; and
change the size of the video window according to parameter values when the parameter values and a confirmation instruction inputted by a user are received by the size input box.

15. The electronic device according to claim 11, wherein in the step of playing the second video in the video window, the at least one processor is further caused to:
determine whether the first video is played in a mute state;
play video images of the second video in the video window and outputting a sound of the second video when the first video is played in the mute state; and
play video images of the second video in the video window and closing the sound of the second video when the first video is played in a non-mute state.
